(19) United States
(12) Patent Application Publication
(10) Pub. No.: US 2012/0242901 A1
(43) Pub. Date: Sep. 27, 2012

(54) METHOD AND APPARATUS FOR DISPLAYING AN ON-SCREEN DISPLAY

(75) Inventor: Bastiaan Johan Engelblik, Eindhoven (NL)

(73) Assignee: Koninklijke Philips Electronics N.V., Eindhoven (NL)

(21) Appl. No.: 13/512,916

(22) PCT Filed: Nov. 25, 2010
(86) PCT No.: PCT/IB2010/055414

§ 371 Date: May 31, 2012

(30) Foreign Application Priority Data
Dec. 4, 2009 (EP) 09177970.2

(51) Int. Cl. H04N 5/50

(52) U.S. Cl. 348/569; 348/E05.097

(57) ABSTRACT

At least one display parameter of an on-screen display based upon the type of user interface device (101, 103) used is determined and the on-screen display is displayed according to the determined at least one display parameter.

### FIELD OF THE INVENTION

The present invention relates to method and apparatus for displaying an on-screen display. In particular, but not exclusively, it relates to adjusting the on-screen display for display on a television, VCR, DVD display etc.

### BACKGROUND OF THE INVENTION

Home entertainment systems such as televisions, home cinema systems, VCR, DVD, computer systems have become increasingly complex. The user is provided with different techniques of interfacing with such systems such as remote control device local control device located in or near the display, touch-sensitive screens etc. Given the complexity of these systems and hence the increase in the complexity and options provided to the user via these user interface devices, it has become increasingly desirable to provide the user with visible feedback of these options. For example the user interface device may be used to control functions such as Ambilight, volume level, program channels, select source and display setting functions and visible feedback of these is useful.

Currently any graphical feedback is provided on a portion of the screen having a predetermined size and location. These are overlaid on the existing displayed content. If the display is large and already cluttered, it can prove difficult for the user to locate and read the graphical feedback. Further, local control devices may be located anywhere on the display, for example, at a location on the perimeter of the display screen. As a result the user is positioned close to the screen and at a particular location of the screen making location and reading of the graphical feedback difficult.

### SUMMARY OF THE INVENTION

The present invention seeks to provide display of graphical feedback on a screen that is easier to locate and read.

This is achieved according to a first aspect of the present invention by a method for displaying an on-screen display comprising the steps of: determining at least one display parameter of an on-screen display based upon the type of user interface device used; displaying the on-screen display according to the determined at least one display parameter.

This is also achieved according to a second aspect of the present invention by apparatus for displaying an on-screen display comprising: at least two user interface devices; a controller for determining at least one display parameter of an on-screen display based upon which of said at least two user interface devices used and causing display of said on-screen display according to said determined at least one display parameter.

An on-screen display may comprises any type of information such as text, a figure, and a menu, other than the images currently displayed. It may include the current settings of the display, allowing the user to change the settings to control various functions of the display. The on-screen display may be an overlay of the currently displayed overlaid contents items. The on-screen display may also include an Electronic Program Guide, a channel list, search menus, and the like.

The type of interface device used gives an indication of the location of the user. For example, the user may use a remote control device and is therefore at a distance from the screen and the no-screen display can then be adjusted to make it easier to find on the screen and easier to read.

The on-screen display provides graphical feedback to the user. Adjusting the display parameters of the on-screen display based on the type of interface device used allows more specific graphical feedback to the user. As the user uses a particular type of user interface device, the user will be aware of the specific on-screen display (graphical feedback) associated with that type of user interface device and will be able to easily locate the on-screen display and hence more easily read it.

In an embodiment of the present invention, the at least one display parameter may include: location of display of an on-screen display; dimensions of an on-screen display; colour contrast of an on-screen display; and content of an on-screen display.

As a result the “look” of the on-screen display can be adjusted to suit the user making the on-screen display easier to find on a large screen or on a screen viewed at a distance and make its content easier to read.

In an embodiment of the present invention, the dimensions of the on-screen display may be adjusted to provide a large size on-screen display if a remote control device is used or a smaller size on-screen display if a local control device such as a control panel located or integral with a display which displays the on-screen display or a touch-sensitive part of the display is used.

The size of the on-screen display may be determined relative to a predetermined threshold, for example, the threshold may be predetermined to provide a nominal sized on-screen display such that if a remote control device is used, the size of the on-screen display is determined to be greater than the predetermined threshold and if a local control device is used, the size of the on-screen display is determined to be less than the predetermined threshold.

Alternatively, the relative sizes may be predetermined for each type of user interface device and prestored such that depending on the type of interface device used, the corresponding prestored sizing parameters are retrieved and used to display the on-screen display.

Alternatively, the size may be determined (in addition to the type of interface device used) by the overall content being currently displayed or by the aspect ratio or size of the current display such that the size of the on-screen display is determined to occupy more of the display if as remote control device is used and occupy less of the display of a local control device is used.

The size of the on-screen display may also be adjusted to take account of the distance of the remote control device from the location of the display. The size of the on-screen display may be increased if the remote control device is used and it is determined to be a greater distance from location of the display.

Further, or alternatively, the location for display of an on-screen display may be determined based on the location of the user interface device used. For example, the local control device may be located at any location anywhere around the perimeter of a display or any part of the display and the location of display of the on-screen display may be determined to be in the vicinity of e.g., next to the location of local control device. Therefore, as the user is close to the screen while using the local control device, the on-screen display is displayed within the line of sight of the user and therefore, the user does not need to search the screen to find and read the on-screen display.

### BRIEF DESCRIPTION OF DRAWINGS

For a more complete understanding of the present invention, reference is made to the following description in conjunction with the accompanying drawings, in which:

FIG. 1 is simple schematic of the apparatus according to an embodiment of the present invention;

FIG. 2 is a flowchart of the method of display an on-screen display according to an embodiment of the present invention; and

FIGS. 3a and 3b are examples of location of display of on-screen displays according to an embodiment of the present invention.

### DETAILED DESCRIPTION OF AN EMBODIMENT OF THE INVENTION

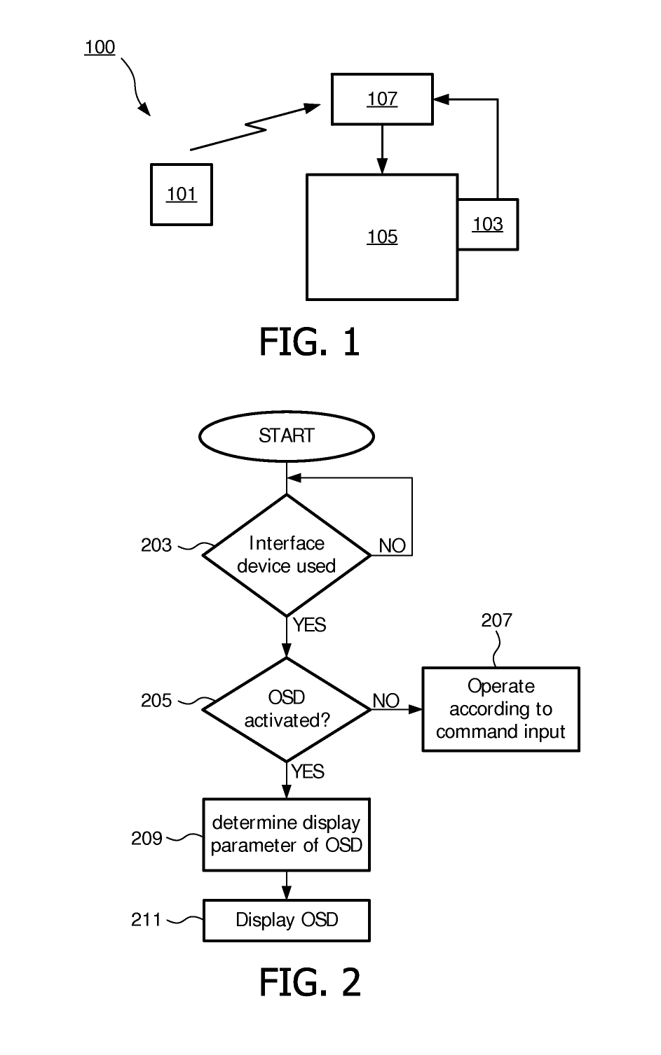

The apparatus 100 of an embodiment of the present invention, as shown in FIG. 1, comprises at least two interface devices 101, 103, a display 105 and a controller 107. Although the display 105 is shown here as part of the apparatus, it can be appreciated that the apparatus may output to control an external display.

The at least two interface devices 101, 103 may comprise, for example a remote control device 101 which communicates wirelessly with the controller 107 or a local control device 103 which may be a panel attached to the display 105, or a control panel integral with the display 105, a part of the display such as a touch-sensitive portion of the display 105, or a keyboard.

The display 105 may be any shape and the local control device 103 may be located anywhere around or near the perimeter of the display 105 or may be located anywhere on the display 105. In FIG. 1, the control device 103 is shown attached to the right hand side of a rectangular display 105. The local control device 103 may be located at the bottom or top side of the display 105 or the left hand side of the display 105. The local control device 103 may be a separate unit attached to the display 105 such as a keyboard which may be hard wired to the controller 107 or communicate wirelessly with the controller 107. Alternatively the local control device 103 may be an integral part of the display such as an integral keypad or touch-sensitive screen.

Operation of the apparatus 100 will now be described with reference to FIG. 2.

Upon use of an interface device 101 or 103, step 203, the controller 107 waits for a request for the on-screen display (OSD), step 205. The controller 107 operates the display 105 according to the commands input by the user via the user interface device 101, 103 used, step 207. If the user requests display of the on-screen display, the display parameters of the on-screen display are determined based on the type of interface device used, step 209. The on-screen display is displayed in step 211.

The parameters may include any one of location of display of an on-screen display; dimensions of an on-screen display; colour contrast of an on-screen display; and content of an on-screen display or any combination thereof. As a result the “look” of the on-screen display can be adjusted to suit the user making the on-screen display easier to find on a large screen or on a screen viewed at a distance and make its content easier to read.

In an embodiment of the present invention, the dimensions of the on-screen display may be adjusted to provide a large size on-screen display if the remote control device 101 is used or a smaller size on-screen display if a local control device 103 such as a control panel located or integral with a display which displays the on-screen display or a touch-sensitive part of the display is used. The size of the on-screen display may be determined relative to a predetermined threshold, for example, the dimensions to provide a nominal sized on-screen display, such that if the remote control device 101 is used, the size of the on-screen display is determined to be greater than the predetermined threshold and if the local control device 103 is used, the size of the on-screen display is determined to be less than the predetermined threshold.

Alternatively, the relative sizes may be predetermined for each type of user interface device and prestored such that depending on the type of interface device used, the corresponding prestored sizing parameters are retrieved and used to display the on-screen display.

Alternatively, the size may be determined (in addition to the type of interface device used) by the overall content being currently displayed or by the aspect ratio or size of the current display such that the size of the on-screen display is determined to occupy more of the display if the remote control device 101 is used and occupy less of the display of the local control device 103 is used.

The size of the on-screen display may also be adjusted to take account of the distance of the remote control device from the location of the display. The size of the on-screen display may be increased if the remote control device is used and it is determined to be a greater distance from the location of the display.

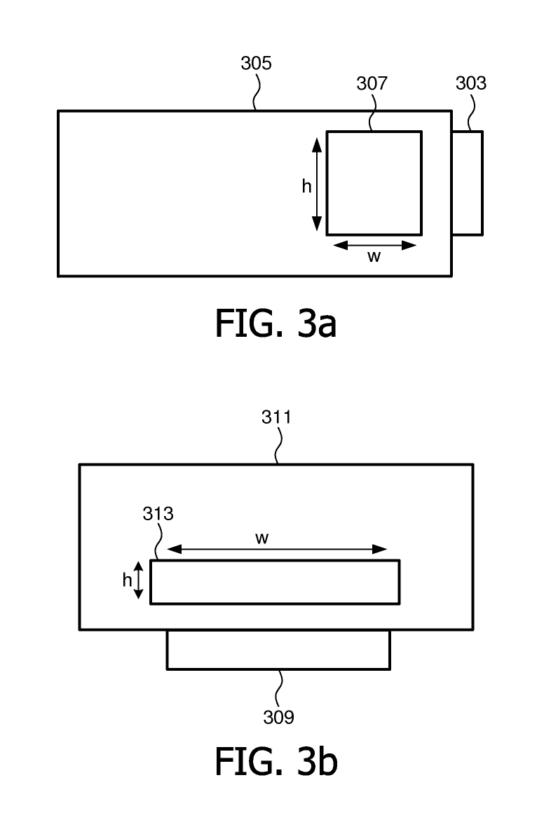

Further, or alternatively, the location for display of an on-screen display may be determined based on the type and/or location of user interface device used. For example, the local control device 103 may be located at any location around the perimeter of the display 105 or may form part of the display and the location of display of the on-screen display may be determined to be on the display next to the location of local control device 103. For example, as shown in FIG. 3a, if the local control device 303 used is located on the right-hand side of a rectangular display 305, the on-screen display 307 is located at the right hand side of the display 305 next to the location of the local control device 303.

In another example, the local control device 309 may be located at the bottom side of the display 311 as shown in FIG. 3b. If this local control device 309 is used, the on-screen display 313 is located in the bottom portion of the display 311. Furthermore, the aspect ratio and/or size of the on-screen display 307, 313 may be varied depending on the location of display. For example, as shown in FIG. 3a, the on-screen display 307 has decreased width w and increased height h compared to that of the on-screen display 313 to fit within the screen, provide an on-screen display that is aesthetically more pleasing etc. Therefore, as the user is close to the screen of the display 105, 305, 309 while using the local control device 103, 303, 309 the on-screen display is displayed within the line of sight of the user and therefore, the user does not need to move their head to search the screen to find and read the on-screen display.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for displaying an on-screen display, comprising:
determining at least one display parameter of an on-screen display based upon the type of user interface device used;
displaying said on-screen display according to said determined at least one display parameter.

2. A method according to claim 1, wherein said at least one display parameter includes:
location of display of an on-screen display; dimensions of an on-screen display; colour contrast of an on-screen display; and content of an on-screen display.

3. A method according to claim 1, wherein determining at least one display parameter of an on-screen display comprises:
determining dimensions to provide a large size on-screen display if a remote control device is used.

4. A method according to claim 3, wherein determining dimensions comprises determining dimensions based on the distance between the remote control device and display of said on-screen display.

5. A method according to claim 1, wherein determining at least one display parameter of an on-screen display comprises determining the location for display of an on-screen display within the vicinity of the location of said user interface device used.

6. A computer program comprising a plurality of program code portions for carrying out the method according to claim 1.

7. Apparatus for displaying an on-screen display, comprising:
at least two user interface devices;
a controller for determining at least one display parameter of an on-screen display based upon which of said the type of at least two user interface devices used and causing display of said on-screen display according to said determined at least one display parameter.

8. Apparatus according to claim 7, wherein the apparatus further comprises a display means for displaying said on-screen display.

9. Apparatus according to claim 8, wherein said at least two user interface devices include a remote control device and a local control device located on said display means.

10. Apparatus according to claim 7, wherein said at least one display parameter includes location of display of an on-screen display; dimensions of an on-screen display;
colour contrast of an on-screen display; and content of an on-screen display.

11. Apparatus according to claim 9, wherein the dimensions of an on-screen display are greater if said remote control device is used and the dimensions of an on-screen display are less if said local control device located on said display means is used.

12. Apparatus according to claim 9, wherein said controller causes display of an on-screen display within the vicinity of the location of said local control device on said display means.
